(19) United States
(12) Patent Application Publication
(10) Pub. No.: US 2026/0194040 A1
(43) Pub. Date: Jul. 9, 2026

(54) WIND TURBINE BLADE COMPONENTS COMPRISING NONWOVEN FABRIC

(71) Applicant: LM WIND POWER A/S, Kolding (DK)

(72) Inventors: Mahdi BAVILOLIAIE, Kolding (DK); Klavs JESPERSEN, Kolding (DK); Michael Scholarth KOEFOED, Kolding (DK)

(21) Appl. No.: 19/129,296

(22) PCT Filed: Nov. 14, 2023
(86) PCT No.: PCT/EP2023/081739

§ 371 Date: May 12, 2025

(30) Foreign Application Priority Data
Nov. 14, 2022 (EP) 22207208.4

(51) Int. Cl. F03D 1/06; F03D 80/30

(52) U.S. Cl. CPC F03D 1/0681; F03D 80/301; F05B 2280/6001; F05B 2280/6003

(57) ABSTRACT

The present invention relates to a wind turbine blade component comprising a laminate structure comprising a non-woven fabric comprising a plurality of first fibres and a plurality of second fibres, wherein the plurality of first fibres are randomly oriented carbon fibres entangled with the plurality of second fibres which are of a type of fibres different from carbon fibres.

### FIELD OF THE INVENTION

The present disclosure relates to wind turbine blade components comprising a non-woven fabric and methods for manufacturing such wind turbine blade components.

### BACKGROUND

Wind power provides a clean and environmentally friendly source of energy. Wind turbines usually comprise a tower, generator, gearbox, nacelle, and one or more rotor blades. The wind turbine blades capture kinetic energy of wind using known airfoil principles. Modern wind turbines may have rotor blades that exceed 90 and even 100 meters in length.

Wind turbine blades are usually manufactured by forming two shell parts or shell halves from layers of woven fabric or fibre and resin. Wind turbine blades comprise a plurality of wind turbine blade components, such as spar caps. Spar caps are placed or integrated in the shell halves and may be combined with other wind turbine blade components such as shear webs or spar beams to form structural support members. Spar caps may be joined to, or integrated within, the inside of the suction and pressure halves of the shell.

Many studies have demonstrated the advantages of using advanced materials compared to conventional materials in the field of wind turbine blades, including using materials with certain desired properties like low weight to reduce gravitational forces, high strength to withstand wind force and gravitational force of the blade, high fatigue resistance to withstand cyclic load, high stiffness to ensure stability of the optimal shape.

However, there is a need to replace some of the advanced and/or conventional materials used for different wind turbine blade components with cheaper, more environmentally friendly materials, without compromising with the properties of the wind turbine blade components.

### SUMMARY

It is an object of the present disclosure to provide wind turbine blade components comprising cheaper, more environmentally friendly materials, without compromising with the properties of the wind turbine blade components. It is a further object of the present disclosure to provide methods for manufacturing such wind turbine blade components.

Thus, in a first aspect, the present disclosure relates to a wind turbine blade component comprising a laminate structure comprising a non-woven fabric comprising a plurality of first fibres and a plurality of second fibres, wherein the plurality of first fibres are randomly oriented carbon fibres entangled with the plurality of second fibres which are of a type of fibres different from carbon fibres.

An important aspect of the present invention is the fact that the plurality of first fibres and the plurality of second fibres are entangled. It is to be understood that the plurality of first fibres are also entangled with one another. In the same way, the plurality of second fibres are also entangled with one another. This is because entanglement of fibres to create a non-woven fabric has several advantages compared to other non-woven fabrics used in the wind turbine industry. A non-woven fabric comprising entangled fibres as described herein is not to be confused with a non-woven fabric simply comprising randomly arranged or mixed fibres, where the fibres are held together by some means, such as by a binding agent or by stitching. Entanglement is herein to be understood as an entanglement of the plurality of first fibres with the plurality of second fibres to an extent where a non-woven fabric which can be handled and transported is created, without the need for further means to hold the fibres together, such as a binding agent or stitching. Thus, in preferred embodiments, the plurality of first fibres and the plurality of second fibres in the non-woven fabric are not held together by a binding agent or by stitching.

The fact that a binding agent or stitching is not needed to create the non-woven fabric is advantageous, since it makes the manufacturing process of the non-woven fabric cheaper and simpler. Furthermore, such a non-woven fabric has some advantageous properties, for example good permeability due to the arrangement of fibres, caused by the entanglement of fibres. This is advantageous if the non-woven fabric is used in wind turbine blade components, for example as interlayers in spar caps, where the permeability of the interlayer is very important for proper binding of the pultrusions in the laminate structure. Also, such fabric has good electric conductivity due to use of carbon fibres, which is particularly advantageous when used in wind turbine components, such as spar caps, since it decreases the risk of lightning strikes causing problems. This is because, wind turbine blade components, such as spar caps, often comprise conductive fibres, e.g. carbon fibres. During thunderstorms, there is a risk that a voltage differential may occur between individual carbon elements and cause damage or even fire in the wind turbine blade component, if the fibres of different elements are not electrically coupled. However, due to the presence of carbon fibres in the non-woven fabric of the present invention, the non-woven fabric is conductive and suitable to use as an interlayer in laminate structures, such as a spar cap for a wind turbine blade.

One method of entangling the plurality of first fibres and the plurality of second fibres to an extent where a non-woven fabric is created without the need for further means to hold the fibres together is needle felting. Needle felting may also be referred to as needle punching. The general principle of the method is to arrange webs or batts of fibre material in layers on a surface and punch a needle with a barb through the fibre material. The barbs of a needle for needle-felting are also called notches and should not be confused with barbs in the form of protrusions (like barbed wire), since such barbs would be too difficult to thrust into the fibres and nearly impossible to pull out. Felting needles are thin and sharp, with shafts of a variety of different gauges and shapes. A needle-felting machine comprises a plurality of needles with angled notches along the shaft that are configured to catch fibers and tangle them together. When the needle is punched through fibre material, some of the fibres are captured by the needle and pressed toward the surface. When the needle is pulled back, the barb will pull some of the fibres upward away from the surface. This needling action interlocks the fibres and holds the structure together. By repeating the process, the fibres will get more and more entangled, until a non-woven fabric which can be handled and transported is created.

In the needle-felting process, the plurality of fibres, including the plurality of first fibres and the plurality of second fibres, are entangled to form a complex, unique network of fibres with a cohesive, fluffy and non-uniform structure comprising a plurality of fibres sticking out of the plane. The needle felt non-woven fabric is easier to drape and more flexible compared to other fabrics. It has good elongation properties in X and Y directions, and can therefore be more easily applied to a complex shape with curvature, e.g. a spar cap mould. Furthermore, the fabric has good stability and handling ability.

As a result of the fibre entanglement, the needle-felt material preferably includes a plurality of interlocking fibres. By interlocking fibres is meant that two fibres are in a configuration within the non-woven fabric where movement of one of the two fibres in one direction results in movement of at least part of the other of the two fibres in the same direction. Interlocking of a large number of fibres contributes to the cohesive structure of the non-woven fabric.

Furthermore, as a result of the fibre entanglement, the needle-felt material preferably includes a plurality of fibres or a plurality of fibre parts having a U-shape configuration. This U-shape configuration may be a created when horizontally arranged fibres are being punched through the fibre material by a needle during the needle-felting process. Furthermore, when the needle is pulled back from the fibre material, it will pull some of the fibres upward, which may create a reversed U-shape configuration. In some embodiments, fibres in the U-shape configuration extend from one larger surface of the non-woven fabric to an opposite larger surface of the non-woven fabric i.e., in the thickness direction.

Thus, in some embodiments, the entangled fibres include a plurality of interlocking fibres and/or a plurality of fibres or a plurality of fibre parts having a U-shape configuration.

A needle felt non-woven fabric can be made by hand but can also be manufactured by using special barbed felting needles on an industrial felting machine.

The construction of needle-felt non-woven fabric may start with large bales of loose fibre material. These bales of fibre may then go into machines called bale breakers. These machines may break the compact bale of fibres apart so that they are easier to process. Many felts involve mixing different types of fibre together in order to get the desired outcome. This may be done by carefully weighing the fibre that goes from the bale breakers into the next step of the process, blending and carding to achieve the correct percentage of the blend. The breaking up and mixing of fibre may be done at carding. Carding may comprise feeding loose beds of fibre into large wired rollers. This wire may separate each strand of fibre, mix and blend the components together and orient the fibre in a single direction. The fibre exits the carding machine in the form of a web. It is the first time the fibre looks like a fabric but, just like cotton candy, this material has very little strength to it. This webbing may be laid onto a conveyor belt which carries the web to a cross-lapper. The lapper may fold each thin layer of webbing over itself which provides weight and thickness to the finished felt. The number of layers depends on the target thickness and weight of the finished product. After the lapper, the layers of webbing may enter a needle loom. A needle loom is a precise machine that uses barbed needles mounted on a needle board to pierce the layered web of fibre. The needle boards punch the fibres at a rate of 600-2,000 punches per minute. This repeated punching of needles entangles the fibres together which creates a strong bond. Needle looms can be “in-line” or “off-line.” This is the end of the felt-making process for some felts. But others go on to receive different finishing treatments such as additional needling or adding more layers of felt to build density, heat treating, calendaring, singeing, and laminating.

In preferred embodiments, the non-woven fabric is a needle felt non-woven fabric. In other words, the non-woven fabric is obtained by needle felting. No water, air, heat and chemicals are needed to make a needle felt non-woven fabric, since needle felting is a pure physical and mechanical bonding method. However, the non-woven fabrics may also be made by other methods, as long as the plurality of first fibres are entangled with the plurality of second fibres to an extent where a non-woven fabric which can be handled and transported, without the need for further means to hold the fibres together, such as a binding agent or stitching.

In some embodiments, the needle-felting process is followed by an additional manufacturing step, such as heated belt-pressing, to further consolidate the non-woven fabric so it is less bulky to handle and lay-up. In some embodiments, small quantities of hot-melt fibre are added to the non-woven fabric, to effectively glue together the fibres in the non-woven fabric in the compacted form that the heated belt-press creates.

In another aspect of the invention, the plurality of fibres may be entangled by punching the plurality of fibres together using air jets or water jets. Thus, in another aspect of the invention, the present disclosure relates to a wind turbine blade component comprising a laminate structure comprising a non-woven fabric comprising a plurality of first fibres and a plurality of second fibres, wherein the plurality of first fibres are randomly oriented carbon fibres entangled with the plurality of second fibres which are of a type of fibres different from carbon fibres, wherein the plurality of first fibres and the plurality of second fibres are entangled by punching them together using air jets or water jets.

In some embodiments the non-woven fabric is reinforced by a stitching pattern. Importantly, such a stitching pattern would not be essential for holding together the plurality of fibres in the non-woven fabric, but only for reinforcing the non-woven fabric or to give the fabric desired flow characteristics. In some embodiments, the stitching pattern is made up by a stitching thread comprising or essentially consisting of polyester fibres. The stitching thread may also be of another material, such as carbon fibres, but the most common technically and commercially is polyester. In some embodiments, the stitching pattern comprises a plurality of stitching rows for stabilizing the fabric for handling purpose. In some embodiments, the plurality of stitching rows are arranged along a longitudinal direction and/or transverse direction of the non-woven fabric. The stitching pattern may be a standard chain stitch or any other type of known stitching pattern.

In preferred embodiments, the wind turbine blade component is a spar cap. The wind turbine blade being a laminated structure means that the wind turbine blade component is a layered structure i.e., a structure comprising several layers of consolidated material. A spar cap is a laminated structure. In preferred embodiments, the laminated structure is a spar cap. Thus, the wind turbine blade component may in some embodiments consist of the laminated structure, which may be a spar cap.

In some embodiments, the plurality of fibres in the non-woven fabric is further held together by binding agent. Importantly, binding agent would not be essential for holding together the plurality of fibres in the non-woven fabric in such embodiments.

In another aspect of the invention, the plurality of fibres are held together by binding agent. Thus, in another aspect of the invention, the present disclosure relates to a wind turbine blade component comprising a laminate structure comprising a non-woven fabric comprising a plurality of first fibres and a plurality of second fibres, wherein the plurality of first fibres are randomly oriented carbon fibres and the plurality of second fibres are of a type of fibres different from carbon fibres, wherein the plurality of first fibres and the plurality of second fibres are held together by binding agent.

In some embodiments, the laminate structure comprises
a plurality of fibre-reinforcing elements, including a first fibre-reinforcing element and a second fibre-reinforcing element; and
a number of non-woven fabrics, including a first non-woven fabric embedded in a first cured resin and being arranged between the first fibre-reinforcing element and the second fibre-reinforcing element.

In some embodiments, the plurality of fibre-reinforcing elements each comprises a plurality of stacked fibre-reinforcing layers. In some embodiments, the plurality of fibre-reinforcing elements are pre-cured fibre-reinforced elements, such as pultrusions comprising carbon fibres and/or glass fibres. In some embodiments, the number of non-woven fabrics are interlayers for promoting resin infusion between the plurality of fibre-reinforcing elements. In some embodiments, the first cured resin is epoxy resin, polyester resin, polyurethane resin, Elium® or vinyl ester resin.

In some embodiments, the non-woven fabric (embedded in the first cured resin) has a thickness between 0.1 mm and 2 mm, preferably between 0.3 mm and 0.5 mm, such as 0.35 mm. This is the thickness of the non-woven fabric in the laminate structure i.e., after being embedded in a first cured resin. The thickness of the non-woven fabric is larger than this before it is embedded in resin and before being part of the laminate structure.

In some embodiments, the non-woven fabric (embedded in the first cured resin) has an area weight between 50 g/m2 and 200 g/m2, preferably between 70 g/m2 and 150 g/m2, such as 75 g/m2, 80 g/m2 or 100 g/m2.

The degree of entanglement of the fibres in the non-woven fabric is correlated with the density of the non-woven fabric. The higher density of the material, the higher degree of entanglement. Thus, a higher density of the non-woven fabric can be achieved by repeating the felting process (by pushing the barbs through the layers of web, the barbs catch the scales on the fibre thereby tangling them and binding them together).

The plurality of first fibres are carbon fibres. In some embodiments, the plurality of second fibres are also carbon fibres i.e., the only fibre type in the non-woven fabric is carbon fibres.

In some embodiment, each of the plurality of carbon fibres are covered in a sizing layer. The sizing layer is a very thin layer of chemicals, which improves bonding between the plurality of carbon fibres in the non-woven fabric and the fibre-reinforcing layers e.g. the pultruded carbon planks of the spar cap. However, the sizing layer have a slight insulating effect on the plurality of carbon fibres. It is known to the skilled person that carbon fibres used in laminate structures are usually covered by a sizing layer.

In preferred embodiments, the plurality of carbon fibres are chopped carbon fibres. In preferred embodiments, the non-woven fabric comprises carbon fibres sticking out of the plane of the fabric. By sticking out of the plane is meant that the fibres or part of fibres extend in a direction which is non-parallel with the two largest surfaces of the non-woven fabric. In some embodiments, some of the fibres sticking out of the plane comprise a part extending perpendicular or substantially perpendicular to the plane i.e. in the thickness direction of the non-woven fabric. In the needle-felt non-woven fabric, some of the fibres may extend from one side of the non-woven fabric to the other side of the non-woven fabric. Thus, if the fabric is sandwiched between two elements, such as two pultruded planks, the fibres will be in contact with both elements. Preferably, the carbon fibres sticking out of the plane of the non-woven fabric are configured to be in contact with the fibre-reinforced layers e.g. the carbon pultruded planks of the spar cap. Chopped carbon fibres sticking out of the plane is advantageous, since the free ends of the chopped carbon fibres are not covered by the sizing layer. Thus, the free ends of the chopped carbon fibres facilitate an electrical path between the non-woven fabric and the fibre-reinforcing layers e.g. pultruded carbon planks of the spar cap. Thus, in preferred embodiments, the non-woven fabric comprises chopped carbon fibres and the ends of the chopped carbon fibres are not covered by a sizing layer and the carbon fibres are sticking out of the planes of the non-woven fabric, preferably sticking out of the upper non-woven fabric surface and/or the lower non-woven fabric surface.

In some embodiments, each of the plurality of carbon fibres have an average length between 1 mm and 10 mm, preferably between 3 mm and 7 mm, such as between 4 mm and 7 mm. In some embodiments, each of the plurality of carbon fibres have an average length between 10 mm and 100 mm, preferably between 30 mm and 70 mm, such as between 40 mm and 70 mm. In some embodiments, the plurality of carbon fibres are carbon fibre tows, such as chopped carbon fibre tows.

In preferred embodiments, the plurality of carbon fibres are recycled or reclaimed carbon fibres. The recycled carbon fibres may be recycled by chopping longer fibres to form chopped carbon fibres with the aforementioned average length. It is advantageous to use such recycled or reclaimed carbon fibres, since it makes the wind turbine component more environmentally friendly. Furthermore, much carbon waste comes from the wind turbine industry. Thus, the use of recycled or reclaimed carbon fibres within the industry makes the wind turbine components comprising a non-woven fabric with recycled carbon fibres sustainable compared to other wind turbine components made from other materials. Reclaimed or recycled fibres cannot be easily used for any type of fabric. However, they are particularly easy to use for a needle-felt non-woven fabric.

In some embodiments, the first fibres are not carbon fibres, but another type of fibres such as glass fibres and/or polymeric fibres. Such embodiments may be preferred if the non-woven fabric is arranged as an interlayer in a spar cap comprising glass fibre pultrusions. In such embodiments, the electric conductivity of the carbon fibres are not needed. With that said, a non-woven fabric comprising carbon fibres will still have cost and fracture toughness advantages, regardless of conductivity, if used as an interlayer between glass pultrusions in a spar cap.

In some embodiments, the plurality of second fibres are monofilaments. The average diameter of the monofilaments may for instance be between 100 and 1000 μm, preferably between 150 and 500 μm, e.g. around 250 μm or 350 μm.

In preferred embodiments, the plurality of second fibres are polymeric fibres, preferably polyester fibres.

In some embodiments, the plurality of polyester fibres have a diameter between 20 μm and 60 μm, such as between 30 μm and 60 μm, such as between 40 μm and 60 μm, such between 50 μm and 60 μm. In some embodiments, the plurality of polyester fibres have a diameter between 20 μm and 50 μm, such as between 20 μm and 50 μm, such as between 30 μm and 50 μm, such as between 40 μm and 50 μm. In some embodiments, the plurality of polyester fibres have a diameter between 35 μm and 60 μm, such as between 35 μm and 55 μm, such as between 35 μm and 50 μm, such as between 35 μm and 45 μm, such as 40 μm.

In some embodiments, the plurality of polyester fibres have an average length between 20-100 mm, such as between 20-90 mm, such as between 20-80 mm, such as between 20-70 mm, such as between 20-60 mm, such as between 20-50 mm, such as between 20-40 mm, such as between 20-30 mm, such as between 30-100 mm, such as between 30-90 mm, such as between 30-80 mm, such as between 30-70 mm, such as between 30-60 mm, such as between 30-50 mm, such as between 30-40 mm. In some embodiments, the plurality of polyester fibres have an average length between 2-10 mm, such as between 2-9 mm, such as between 2-8 mm, such as between 2-7 mm, such as between 2-6 mm, such as between 2-5 mm, such as between 2-4 mm, such as between 2-3 mm, such as between 3-10 mm, such as between 3-9 mm, such as between 3-8 mm, such as between 3-7 mm, such as between 3-6 mm, such as between 3-5 mm, such as between 3-4 mm.

In some embodiments, the plurality of carbon fibres are carbon fibre tows, such as chopped carbon fibre tows, and the second plurality of fibres are monofilaments. The combination of monofilaments and carbon fibre tows has been found to provide a good balance between the requirements for flow properties and electrical conductivity.

In some embodiments, the ratio between the plurality of carbon fibres and the plurality of second fibres in the non-woven fabric is between 3:1 and 1:0, such as between 19:1 and 1:0 i.e. the amount of carbon fibres in the non-woven fabric is between 75% and 100%, such as between 95% and 100%. In some embodiments, the ratio between the plurality of carbon fibres and the plurality of second fibres in the non-woven fabric is between 1:3 and 3:1, such as between 1:2 and 2:1. Such ratios have been found to provide an optimum balance between achieving the desired flow properties and characteristics for electric conductivity. In some embodiments, the ratio in volume % between the plurality of carbon fibres and the plurality of second fibres in the non-woven fabric is between 1:3 and 3:1, such as between 1:2 and 2:1. In some embodiments, the ratio in weight % between the plurality of carbon fibres and the plurality of second fibres in the non-woven fabric is between 1:3 and 3:1, such as between 1:2 and 2:1.

In some embodiments, the non-woven fabric further comprises a plurality of third fibres of a fibre type different from carbon fibres and polyester fibres. However, in some embodiments, the non-woven fabric only comprises two types of fibres.

Preferably, the non-woven fabric comprising the plurality of first fibres entangled with the plurality of second fibres is created as a fibre mat, which can be rolled up for storage and rolled out for use.

In a second aspect, the present invention relates to a method of manufacturing a wind turbine blade component, such as a spar cap, according to the first aspect of the present invention, wherein the method comprises the steps of:
providing a plurality of fibre-reinforcing elements including a first fibre-reinforcing element and a second fibre-reinforcing element;
providing a number of non-woven fabrics, including a first non-woven fabric comprising a first plurality of fibres and a second plurality of fibres, wherein the first plurality of fibres are randomly oriented carbon fibres entangled with the second plurality of fibres which are a type of fibres different from carbon fibres;
arranging the first non-woven fabric in between the first fibre-reinforcing element and the second fibre-reinforcing element such that the fibre-reinforcing elements are separated by the first non-woven fabric;
infusing a first resin between the plurality of fibre-reinforcing elements and the number of non-woven fabrics;
curing the resin in order to form the wind turbine blade component.

In some embodiments, the step of providing a first non-woven fabric according to the first aspect of the present invention includes the steps of:
providing a number of webs or batts comprising a first plurality of fibres and a second plurality of fibres, wherein the first plurality of fibres are carbon fibres and the second plurality of fibres are a type of fibres different from carbon fibres, and
needle felting the first and second plurality of fibres to entangle the fibres until a predetermined area weight is obtained.

In preferred embodiments, the wind turbine blade component is a spar cap.

In some embodiments, the plurality of fibre-reinforcing elements each comprises a plurality of stacked fibre-reinforcing layers. In some embodiments, the plurality of fibre-reinforcing elements are pre-cured fibre-reinforced elements, such as pultruded elements (also called pultrusions), comprising carbon fibres and/or glass fibres. In some embodiments, the number of non-woven fabrics are interlayers for promoting resin infusion between the plurality of fibre-reinforcing elements. In some embodiments, the first cured resin is epoxy resin, polyester resin, polyurethane resin, Elium® or vinyl ester resin.

In some embodiments, the plurality of first fibres i.e., the carbon fibres, are recycled carbon fibres, and the step of providing the recycled carbon fibres includes recycling carbon fibres from wind turbine blade parts. In some embodiments, recycling carbon fibres from wind turbine blade parts includes burning pultrusions from spar caps to obtain the recycled carbon fibres. In some embodiments, the recycled carbon fibres are chopped carbon fibres.

The needle felting manufacturing process provides the non-woven fabric with certain properties, which may not be obtained by other manufacturing processes. This is because the fibres are entangled in a particular way by this technique.

Thus, in a third aspect, the wind turbine component of the present invention is obtainable by the method according to the second aspect of the invention.

In a fourth aspect, the present invention relates to a method of manufacturing a wind turbine blade comprising a wind turbine blade component, such as a spar cap, according to the first aspect of the present invention, wherein the method includes the steps of manufacturing a pressure side shell half and a suction side shell half over substantially the entire length of the wind turbine blade and subsequently closing and joining the shell halves for obtaining a closed shell, wherein manufacturing the pressure side shell half or the suction side shell half comprises the steps of:
providing a blade mould for a blade shell member, the blade mould comprising a moulding surface;
arranging a number of fibre reinforcing layers on the blade moulding surface;
providing a pre-manufactured laminate structure comprising a plurality of fibre-reinforcing elements and a plurality of non-woven fabrics embedded in a first cured resin, and arranging the pre-manufactured laminate structure on the fibre-reinforced layers in the blade mould; or
stacking a plurality of fibre-reinforcing elements on the fibre-reinforced layers in the blade mould, wherein a number of non-woven fabrics are arranged between some of the fibre-reinforcing elements;
covering the plurality of fibre-reinforcing elements and non-woven fabrics in the blade mould with a cover to form a cavity and infusing the cavity with a first resin;
optionally curing the resin to form the blade shell member,
   wherein the non-woven fabrics comprise a first plurality of fibres and a second plurality of fibres, wherein the first plurality of fibres are randomly oriented carbon fibres entangled with the second plurality of fibres which are a type of fibres different from carbon fibres.

In some embodiments, the fibre-reinforcing elements are pultrusions comprising carbon fibres and/or glass fibres, and wherein the non-woven fabrics are interlayers for promoting resin infusion between the pultrusions and being arranged between each of the stacked pultrusions.

In a fifth aspect, the present invention relates to a wind turbine blade comprising a wind turbine blade component according to the first aspect of the invention.

The different aspects of the invention may each be combined with the different embodiments described above. The embodiments and features described above for the different aspects of the invention likewise apply to the other aspects of the invention.

### BRIEF DESCRIPTION OF THE FIGURES

Embodiments of the disclosure will be described in more detail in the following with regard to the accompanying figures. The figures show one way of implementing the present disclosure and are not to be construed as being limiting to other possible embodiments falling within the scope of the attached claim set.

FIG. 1 is a schematic diagram illustrating a wind turbine.

FIG. 2 is a schematic diagram illustrating a wind turbine blade and a spar cap structure arranged within the wind turbine blade,

FIG. 3 is a schematic diagram illustrating a cross-sectional view of a spar cap comprising an interlayer arranged between fibre-reinforcing elements,

and

FIG. 4 is a schematic diagram illustrating a cross-sectional view of a non-woven fabric comprising a plurality of carbon fibres entangled with a plurality of second fibres, such as polyester fibres.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

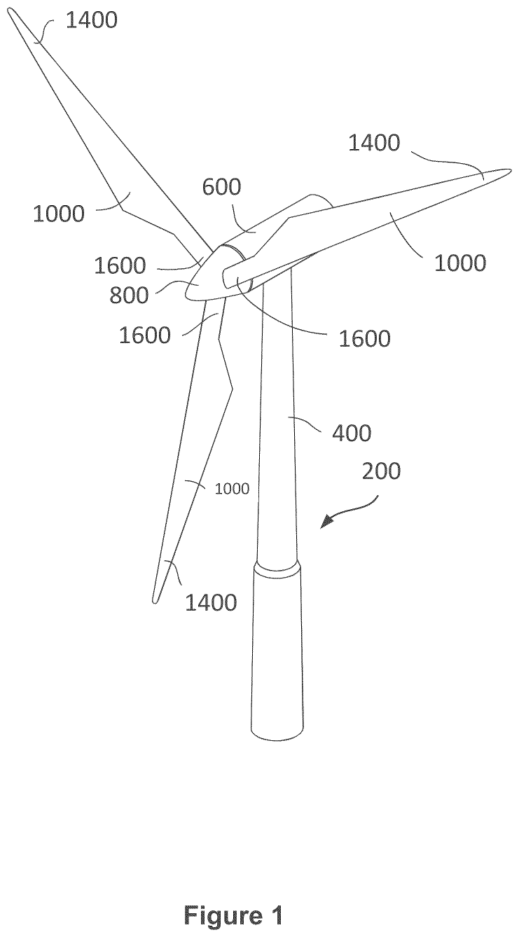

FIG. 1 illustrates a conventional modern upwind wind turbine according to the so-called “Danish concept” with a tower 400, a nacelle 600 and a rotor with a substantially horizontal rotor shaft. The rotor includes a hub 800 and three blades 1000 extending radially from the hub 800, each having a blade root 1600 nearest the hub and a blade tip 1400 furthest from the hub 800.

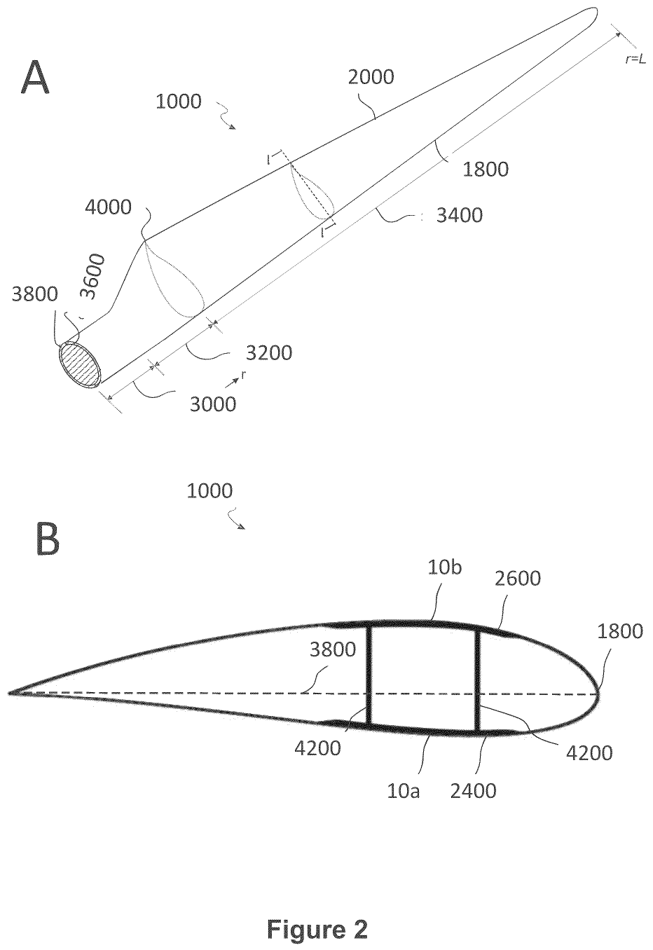

FIG. 2A shows a schematic view of a first embodiment of a wind turbine blade 1000. The wind turbine blade 1000 has the shape of a conventional wind turbine blade and comprises a root region 3000 closest to the hub, a profiled or an airfoil region 3400 furthest away from the hub and a transition region 3200 between the root region 3000 and the airfoil region 3400. The blade 1000 comprises a leading edge 1800 facing the direction of rotation of the blade 1000, when the blade is mounted on the hub, and a trailing edge 2000 facing the opposite direction of the leading edge 1800.

The airfoil region 3400 (also called the profiled region) has an ideal or almost ideal blade shape with respect to generating lift, whereas the root region 3000 due to structural considerations has a substantially circular or elliptical cross-section, which for instance makes it easier and safer to mount the blade 1000 to the hub. The diameter (or the chord) of the root region 3000 may be constant along the entire root area 3000. The transition region 3200 has a transitional profile gradually changing from the circular or elliptical shape of the root region 3000 to the airfoil profile of the airfoil region 3400. The chord length of the transition region 3200 typically increases with increasing distance r from the hub. The airfoil region 3400 has an airfoil profile with a chord extending between the leading edge 1800 and the trailing edge 2000 of the blade 1000. The width of the chord decreases with increasing distance r from the hub.

A shoulder 4000 of the blade 1000 is defined as the position, where the blade 1000 has its largest chord length. The shoulder 4000 is typically provided at the boundary between the transition region 3200 and the airfoil region 3400.

It should be noted that the chords of different sections of the blade normally do not lie in a common plane, since the blade may be twisted and/or curved (i.e. pre-bent), thus providing the chord plane with a correspondingly twisted and/or curved course, this being most often the case in order to compensate for the local velocity of the blade being dependent on the radius from the hub.

FIG. 2B is a schematic diagram illustrating a cross-sectional view of an exemplary wind turbine blade 1000, e.g. a cross-sectional view of the airfoil region of the wind turbine blade 1000. The wind turbine blade 1000 comprises a leading edge 1800, a trailing edge 2000, a pressure side 2400, a suction side 2600, a first spar cap 10a, and a second spar cap 10b. The wind turbine blade 1000 comprises a chord line 3800 between the leading edge 1800 and the trailing edge 2000. The wind turbine blade 1000 comprises shear webs 4200, such as a leading edge shear web and a trailing edge shear web. The shear webs 4200 could alternatively be a spar box with spar sides, such as a trailing edge spar side and a leading edge spar side. The spar caps 10a, 10b may comprise carbon fibres, while the rest of the shell parts 2400, 2600 may comprise glass fibres.

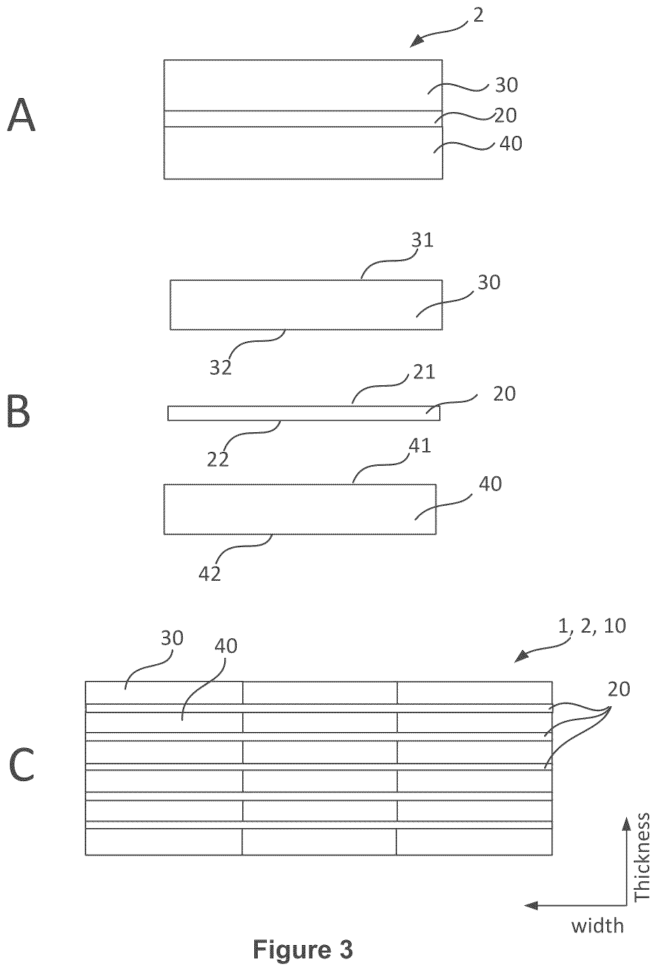

FIG. 3A is a schematic diagram illustrating a cross-sectional view of a laminate structure 2 comprising a first fibre-reinforcing element 30 and a second fibre-reinforcing element 40, as well as a first non-woven fabric 20 embedded in a first cured resin (not visible in the illustration) and being arranged between the first fibre-reinforcing element 30 and the second fibre-reinforcing element 40.

The non-woven fabric 20 and the fibre-reinforcing elements 30, 40 each have a length in a longitudinal direction, a width in a width direction, and a thickness in a thickness direction. The length is longer than the width, and the width is larger than the thickness. The width and length of the non-woven fabric define a plane of the non-woven fabric. In FIG. 3A, the width and thickness of the non-woven fabric 20 and the fibre-reinforcing elements can be seen, but not the length.

In preferred embodiments, the first and a second fibre-reinforcing elements 30, 40 are pultruded carbon fibre elements, e.g. pultrusions, and the non-woven fabric 20 is an interlayer for promoting resin infusion between the fibre-reinforcing elements 30, 40. The first and second fibre-reinforcing elements 30, 40 and the non-woven fabric 20 together make up a laminate structure 2 which may form part of a wind turbine blade component 1, e.g. a spar cap 10 to be arranged in a wind turbine blade, such as the spar caps 10a, 10b of the wind turbine blade 1000 as illustrated in FIG. 2.

FIG. 3B is a schematic diagram illustrating an exploded view of FIG. 3A. The non-woven fabric 20, in the illustrated example, comprises an upper non-woven fabric surface 21 and a lower non-woven fabric surface 22. In the same way, the first fibre-reinforcing element 30 has a first upper surface 31 and a first lower surface 32 and the second fibre-reinforcing element 40 has a second upper surface 41 and a second lower surface 42.

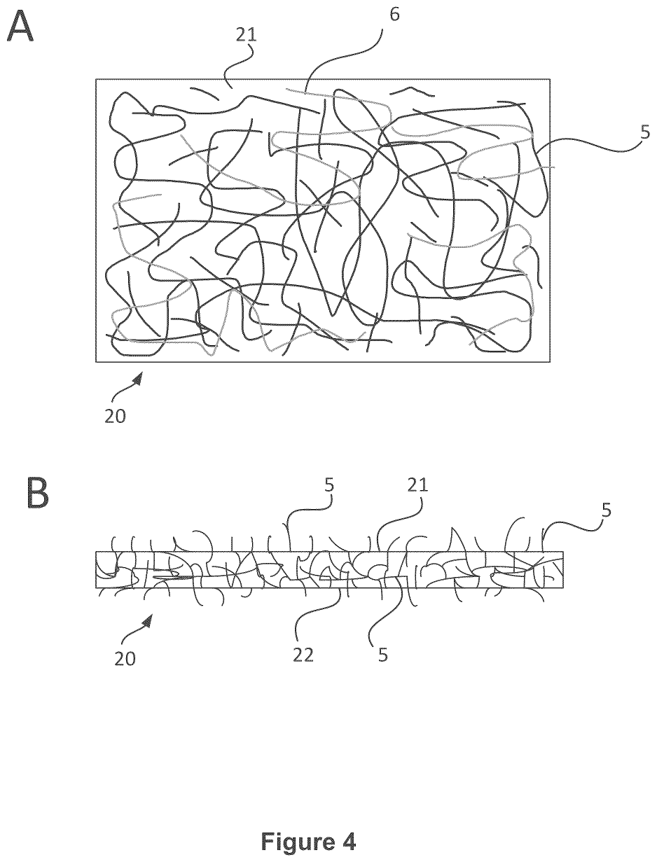

The first fibre-reinforcing element 30 and the second fibre-reinforcing element 40 are arranged such that the first lower surface 32 of the first fibre-reinforcing element 50 is facing the second upper surface 41 of the second fibre-reinforcing element 40. The non-woven fabric 20 is arranged between the lower surface 32 of the first fibre-reinforcing element 30 and the upper surface 41 of the second fibre-reinforcing element 40, e.g. such that the upper non-woven fabric surface 21 is in contact with the first lower surface 32 and the lower non-woven fabric surface 22 is in contact with the second upper surface 41. In preferred embodiments, the non-woven fabric comprises chopped carbon fibres sticking out of the plane of the fabric (See FIG. 4B).

FIG. 3C is a schematic diagram illustrating a cross-sectional view of a wind turbine blade component 1 comprising a laminate structure 2 (layered structure) of fibre-reinforcing elements and non-woven fabrics 20. In this case, the wind turbine blade component 1 is a spar cap 10 for a wind turbine blade, such as the spar caps 10a, 10b of the wind turbine blade 1000 as illustrated in FIG. 2.

The wind turbine blade component 1, i.e. the spar cap 10, comprises a laminate structure 2 (layered structure) comprising a plurality of fibre-reinforcing elements, such as pultrusions comprising carbon fibres and/or glass fibres, including a first fibre-reinforcing element 30 and a second fibre-reinforcing element 40. The plurality of fibre-reinforcing elements each comprises a plurality of stacked fibre-reinforcing layers. The plurality of fibre-reinforcing elements 30, 40 are arranged in an array with three rows of fibre-reinforcing elements arranged adjacent to each other. Each row comprises three fibre-reinforcing elements arranged adjacent to each other. The rows are separated by non-woven fabrics 20. In this embodiment, the non-woven fabrics 20 are interlayers for promoting resin infusion between the plurality of fibre-reinforcing elements. The interlayers are embedded in a first cured resin (not visible in illustration) to hold the laminate structure 2 together.

It is of course clear that the spar cap 10 may comprise other number of layers and juxtaposed fibre-reinforcing elements. Although not specifically illustrated, the non-woven fabrics 20 may also be provided between adjacent elements in the width direction, to facilitate resin flow between elements also in this direction.

Even though not illustrated in FIGS. 3A-3C, the non-woven fabric 20 of the wind turbine blade component 1 comprises a plurality of first fibres 5 and a plurality of second fibres 6, wherein the plurality of first fibres 5 are randomly oriented carbon fibres entangled with the plurality of second fibres 6 which are of a type of fibres different from carbon fibres.

Preferably, the non-woven fabric 20 is a needle felt non-woven fabric. In such embodiments, the plurality of first fibres 5 and the plurality of second fibres 6 in the non-woven fabric 20 are not held together by a binding agent or by stitching, since this is not needed. However, the non-woven fabric 20 may be reinforced by a stitching pattern, wherein the stitching pattern is made up by a stitching thread comprising or essentially consisting of polyester fibres, wherein the stitching pattern comprises a plurality of stitching rows for stabilizing the fabric for handling purpose.

Preferably, the plurality of carbon fibres are recycled or reclaimed carbon fibres, wherein each of the plurality of carbon fibres have an average length between 10 mm and 100 mm, preferably between 30 mm and 70 mm, and the plurality of second fibres 6 are polymeric fibres, preferably polyester fibres having a diameter between 20 μm and 60 μm, such as 40 μm and an average length between 20-100 mm. Preferably, the plurality of carbon fibres are recycled or reclaimed carbon fibres, wherein each of the plurality of carbon fibres have an average length between 1 mm and 10 mm, preferably between 3 mm and 7 mm, and the plurality of second fibres 6 are polymeric fibres, preferably polyester fibres having a diameter between 20 μm and 60 μm, such as 40 μm and an average length between 2-10 mm. Preferably, the ratio between the plurality of carbon fibres and the plurality of second fibres 6 in the non-woven fabric 20 is between 1:3 and 3:1.

The non-woven fabric 20 may further comprise a plurality of third fibres of a fibre type different from carbon fibres and polyester fibres.

Preferably, the non-woven fabric 20, embedded in the first cured resin, has a thickness between 0.1 mm and 2 mm, preferably between 0.3 mm and 0.5 mm, such as 0.35 mm and an area weight between 50 g/m2 and 200 g/m2, preferably between 70 g/m2 and 150 g/m2, such as 75 g/m2, 80 g/m2 or 100 g/m2.

FIG. 4A is a schematic diagram illustrating a top-view of an embodiment of a non-woven fabric 20, which can be used in a wind turbine blade component 1 according to the present invention.

As can be seen in FIG. 4A, the non-woven fabric comprises a plurality of first fibres 5 and a plurality of second fibres 6. The plurality of first fibres 5 are randomly oriented carbon fibres 5 as described in relation to FIG. 3C, entangled with the plurality of second fibres 6 which are of a type of fibres different from carbon fibres 6, preferably polyester fibres, as also described in relation to FIG. 3C.

The size of the plurality of first and second fibres are exaggerated for illustrative purposes. The plurality of first fibres 5, i.e. carbon fibres, are illustrated by black lines, and the plurality of second fibres e.g. polyester fibres are illustrated by grey lines. The plurality of first and second fibres have different lengths but should have an average length between 1 mm-100 mm and 2 mm-200 mm, such as between 1 mm-10 mm and 2 mm-10 mm or 10 mm-100 mm and 20 mm-100 mm respectively. In FIG. 4, there are more of the first plurality of fibres than the second plurality of fibres, and the ratio between the plurality of carbon fibres 5 and the plurality of second fibres 6 in the non-woven fabric 20 is between around 3:1.

The entanglement of fibres is not illustrated in a way that resembles reality. FIG. 4A is merely a schematic illustration showing the presence of two different fibre types in a non-woven fabric 20 according to an embodiment of the present invention.

FIG. 4B is a schematic diagram illustrating a cross-sectional view of embodiment of a non-woven fabric 20, which can be used in a wind turbine blade component 1 according to the present invention.

Only a plurality of first fibres 5 is shown in FIG. 4B. The plurality of first fibres 5 are entangled and randomly oriented carbon fibres 5 as described in relation to FIG. 3C.

Each of the plurality of carbon fibres are covered in a sizing layer. The sizing layer is a very thin layer of chemicals, which improves bonding between the plurality of carbon fibres in the non-woven fabric and the fibre-reinforcing layers e.g. the pultruded carbon planks of the spar cap. It is known to the skilled person that carbon fibres used in the industry is usually covered by a sizing layer.

In FIG. 4B, the non-woven fabric 20 comprises chopped carbon fibres sticking out of the plane of the non-woven fabric. In FIG. 4B, the planes in which the carbon fibres are sticking out, is the upper non-woven fabric surface 21 and the lower non-woven fabric surface 22 of the non-woven fabric. In this way, the end of the chopped carbon fibres are configured to be in contact with the fibre-reinforced layers 30, 40 e.g. the carbon pultruded planks of the spar cap. Carbon fiber sticking out of the plane is advantageous, since the free ends of the chopped carbon fibres are not covered by the sizing layer. Thus, the free ends of the chopped carbon fibres are configured to facilitate an electrical path between the non-woven fabric 20 and the fibre-reinforcing layers 30, 40 e.g. pultruded carbon planks of the spar cap. The carbon fibres 5 are preferably between 4 mm and 7 mm. If the carbon fibres 5 were longer, fewer carbon fibres 5 would stick out of the plane. With that said, chopped carbon fibres 5 with other lengths e.g. shorter or longer than 4 mm and 7 mm, respectively, will still contribute to the out-of-plane fibre orientation and electrical conductivity. Furthermore, if the carbon fibres 5 were not chopped, the free ends of each of the carbon fibres 5 would be covered by a slightly insulation sizing layer.

The disclosure has been described with reference to a preferred embodiment. However, the scope of the invention is not limited to the illustrated embodiment, and alterations and modifications can be carried out without deviating from the scope of the invention. Throughout the description, the use of the terms “first”, “second” etc. does not imply any particular order or importance but are included to identify individual elements. Furthermore, the labelling of a first element does not imply the presence of a second element and vice versa.

### ITEMIZED LIST OF EMBODIMENTS

1. A wind turbine blade component comprising a laminate structure comprising a non-woven fabric comprising a plurality of first fibres and a plurality of second fibres, wherein the plurality of first fibres are randomly oriented carbon fibres entangled with the plurality of second fibres which are of a type of fibres different from carbon fibres.
2. A wind turbine blade component according to item 1, wherein the non-woven fabric is a needle felt non-woven fabric.
3. A wind turbine blade component (1) according to any of the preceding items, wherein the plurality of first fibres is entangled with the plurality of second fibres to an extent where the non-woven fabric can be handled and transported without the need for further means to hold the fibres together.
4. A wind turbine blade component according to any of the preceding items, wherein the non-woven fabric comprises chopped carbon fibres and the ends of the chopped carbon fibres are not covered by a sizing layer
5. A wind turbine blade component according to any of the preceding claims, wherein the carbon fibres are sticking out of the planes of the non-woven fabric, preferably sticking out of the upper non-woven fabric surface and/or the lower non-woven fabric surface.
6. A wind turbine blade component according to any of the preceding items, wherein each of the plurality of first fibres, i.e. carbon fibres, have an average length between 10 mm and 100 mm, preferably between 30 mm and 70 mm.
7. A wind turbine blade component according to any of the preceding items, wherein the plurality of first fibres, i.e. carbon fibres, are recycled or reclaimed carbon fibres.
8. A wind turbine blade component according to any of the preceding items, wherein the plurality of second fibres are polymeric fibres, preferably polyester fibres.
9. A wind turbine blade component according to any of the preceding items, wherein the plurality of polyester fibres have a diameter between 20 μm and 60 μm, such as 40 μm.
10. A wind turbine blade component according to any of the preceding items, wherein the plurality of polyester fibres have an average length 20-100 mm.
11. A wind turbine blade component according to any of the preceding items, wherein the non-woven fabric further comprises a plurality of third fibres of a fibre type different from carbon fibres and polyester fibres.
12. A wind turbine blade component according to any of the preceding items, wherein the ratio between the plurality of carbon fibres and the plurality of second fibres in the non-woven fabric is between 1:3 and 3:1
13. A wind turbine blade component according to any of the preceding items, wherein the non-woven fabric is embedded in a first cured resin.
14. A wind turbine blade component according to any of the preceding items, wherein the first cured resin is epoxy resin, polyester resin, polyurethane resin, Elium® or vinyl ester resin.
15. A wind turbine blade component according to any of the preceding items, wherein the non-woven fabric has a thickness between 0.1 mm and 2 mm, preferably between 0.3 mm and 0.5 mm, such as 0.35 mm.
16. A wind turbine blade component according to any of the preceding items, wherein the non-woven fabric has an area weight between 50 g/m2 and 200 g/m2, preferably between 70 g/m2 and 150 g/m2, such as 75 g/m2, 80 g/m2 or 100 g/m2.
17. A wind turbine blade component according to any of the preceding items, wherein the non-woven fabric is reinforced by a stitching pattern.
18. A wind turbine blade component according to any of the preceding items, wherein the stitching pattern is made up by a stitching thread comprising or essentially consisting of polyester fibres.
19. A wind turbine blade component according to any of the preceding items, wherein the stitching pattern comprises a plurality of stitching rows for stabilizing the fabric for handling purpose.
20. A wind turbine blade component according to any of the preceding items, wherein the plurality of stitching rows are arranged along a longitudinal direction and/or transverse direction of the non-woven fabric.
21. A wind turbine blade component according to any of the preceding items, wherein the plurality of first fibres and the plurality of second fibres in the non-woven fabric are not held together by a binding agent or by stitching.
22. A wind turbine blade component according to any of the preceding items, wherein the laminate structure further comprises
   a plurality of fibre-reinforcing elements, including a first fibre-reinforcing element and a second fibre-reinforcing element; and
   a number of non-woven fabrics, including a first non-woven fabric embedded in a first cured resin and being arranged between the first fibre-reinforcing element and the second fibre-reinforcing element.
23. A wind turbine blade component according to item 22, wherein the plurality of fibre-reinforcing elements each comprises a plurality of stacked fibre-reinforcing layers.
24. A wind turbine blade component according to item 22 or 23, wherein the plurality of fibre-reinforcing elements are pre-cured fibre-reinforced elements, such as pultrusions comprising carbon fibres and/or glass fibres.
25. A wind turbine blade component according to any of items 22-24, wherein the number of non-woven fabrics are interlayers for promoting resin infusion between the plurality of fibre-reinforcing elements.
26. A wind turbine blade component according to any of items 22-25, wherein the first cured resin is epoxy resin, polyester resin, polyurethane resin, Elium® or vinyl ester resin.
27. A wind turbine blade component according to any of the preceding items, wherein the wind turbine blade component is a spar cap.
28. A method of manufacturing a wind turbine blade component, such as a spar cap, the method comprising the steps of:
   providing a plurality of fibre-reinforcing elements including a first fibre-reinforcing element (30) and a second fibre-reinforcing element;
   providing a number of non-woven fabrics, including a first non-woven fabric comprising a first plurality of fibres and a second plurality of fibres, wherein the first plurality of fibres are randomly oriented carbon fibres entangled with the second plurality of fibres which are a type of fibres different from carbon fibres,
   arranging the first non-woven fabric in between the first fibre-reinforcing element and the second fibre-reinforcing element such that the fibre-reinforcing elements are separated by the first non-woven fabric;
   infusing a first resin between the plurality of fibre-reinforcing elements and the number of non-woven fabrics;
   curing the resin in order to form the wind turbine blade component.
29. A method of manufacturing a wind turbine blade component, such as a spar cap, according to item 28, wherein the step of providing a first non-woven fabric includes the steps of:
   providing a number of webs or batts comprising first plurality of fibres and a second plurality of fibres, wherein the first plurality of fibres are carbon fibres and the second plurality of fibres are a type of fibres different from carbon fibres, and
   needle felting the first and second plurality of fibres to entangle the fibres until a predetermined area weight is obtained.
30. A method of manufacturing a wind turbine blade component according to item 29, wherein the plurality of fibre-reinforcing elements each comprises a plurality of stacked fibre reinforcing layers.
31. A method of manufacturing a wind turbine blade component according to any of items 29 or 30, wherein the plurality of fibre-reinforcing elements are pre-cured fibre-reinforced elements, such as pultrusions comprising carbon fibres and/or glass fibres.
32. A method of manufacturing a wind turbine blade component according to any of items 28-31, wherein the number of non-woven fabrics are interlayers for promoting resin infusion between the plurality of fibre-reinforcing elements.
33. A method of manufacturing a wind turbine blade component according to any of items 28-32, wherein the first cured resin is epoxy resin, polyester resin, polyurethane resin, Elium® or vinyl ester resin.
34. A method of manufacturing a wind turbine blade component according to any of items 28-33, wherein the carbon fibres are recycled carbon fibres and the step of providing the recycled carbon fibres includes recycling carbon fibres from wind turbine blade parts.
35. A method of manufacturing a wind turbine blade component according to any of items 29-34, wherein recycling carbon fibres from wind turbine blade parts includes burning pultrusions from spar caps to obtain the recycled carbon fibres.
36. A method of manufacturing a wind turbine blade component according to any of items 32-35, wherein the recycled carbon fibres are chopped carbon fibres.
37. Method of manufacturing a wind turbine blade comprising a wind turbine blade component, such as a spar cap, according to any of items 1-27, the method including the steps of manufacturing a pressure side shell half and a suction side shell half over substantially the entire length of the wind turbine blade and subsequently closing and joining the shell halves for obtaining a closed shell, wherein manufacturing the pressure side shell half or the suction side shell half comprises the steps of:
   providing a blade mould for a blade shell member, the blade mould comprising a moulding surface;
   arranging a number of fibre reinforcing layers on the blade moulding surface;
   providing a pre-manufactured laminate structure comprising a plurality of fibre-reinforcing elements and a plurality of non-woven fabrics embedded in a first cured resin, and arranging the pre-manufactured laminate structure on the fibre-reinforced layers in the blade mould; or
   stacking a plurality of fibre reinforcing elements on the fibre-reinforced layers in the blade mould, wherein a number of non-woven fabrics are arranged between some of the fibre-reinforcing elements;
   covering the plurality of fibre-reinforcing elements and non-woven fabrics in the blade mould with a cover to form a cavity and infusing the cavity with a first resin;
   optionally curing the resin to form the blade shell member
      wherein the non-woven fabrics comprise a first plurality of fibres and a second plurality of fibres, wherein the first plurality of fibres are randomly oriented carbon fibres entangled with the second plurality of fibres which are a type of fibres different from carbon fibres.
38. Method of manufacturing a wind turbine blade comprising a spar cap according to item 37, wherein the fibre-reinforcing elements are pultrusions comprising carbon fibres and/or glass fibres, and wherein the non-woven fabrics are interlayers for promoting resin infusion between the pultrusions and being arranged between each of the stacked pultrusions.
39. A wind turbine blade comprising a wind turbine blade component according to any of items 1-27.

### LIST OF REFERENCES

200 wind turbine
400 tower
600 nacelle
800 hub
1000 blade
1400 blade tip
1600 blade root
1800 leading edge
2000 trailing edge
2200 pitch axis
2400 pressure side
2600 suction side
3000 root region
3200 transition region
3400 airfoil region
4000 shoulder/position of maximum chord
4200 shear web
1 wind turbine blade component
2 laminate structure
5 plurality of first fibres i.e. carbon fibres
6 plurality of second fibres e.g. polyester fibres
10 spar cap
10a first spar cap
10b second spar cap
20 non-woven fabric e.g. interlayer for a spar cap
21 upper non-woven fabric surface
22 lower non-woven fabric surface
30 first fibre-reinforcing element e.g. pultrusion for a spar cap
31 first upper surface
32 first lower surface
40 second fibre-reinforcing element e.g. pultrusion for a spar cap
41 second upper surface
42 second lower surface

1. A wind turbine blade (1) component comprising a laminate structure (2) comprising a non-woven fabric (20) comprising a plurality of first fibres (5) and a plurality of second fibres (6), wherein the plurality of first fibres (5) are randomly oriented carbon fibres entangled with the plurality of second fibres (6) which are of a type of fibres different from carbon fibres.

2. A wind turbine blade component (1) according to claim 1, wherein the non-woven fabric (20) is a needle felt non-woven fabric.

3. A wind turbine blade component (1) according to claim 1, wherein the plurality of first fibres is entangled with the plurality of second fibres to an extent where the non-woven fabric can be handled and transported without the need for further means to hold the fibres together.

4. wind turbine blade component (1) according to claim 1, wherein the plurality of first fibres (5) are recycled or reclaimed carbon fibres and/or wherein the plurality of second fibres (6) are polymeric fibres, preferably polyester fibres.

5. A wind turbine blade component according to claim 1, wherein the non-woven fabric comprises chopped carbon fibres and the ends of the chopped carbon fibres are not covered by a sizing layer and/or wherein the carbon fibres are sticking out of the planes of the non-woven fabric, preferably sticking out of the upper non-woven fabric surface and/or the lower non-woven fabric surface.

6. A wind turbine blade component (1) according to claim 1, wherein each of the plurality of first fibres (5) have an average length between 10 mm and 100 mm, preferably between 30 mm and 70 mm and/or wherein the plurality of second fibres (6) have a diameter between 20 μm and 60 μm and/or wherein the plurality of second fibres have an average length between 20-100 mm.

7. A wind turbine blade component (1) according to claim 1, wherein the ratio in volume % between the plurality of first fibres (5) and the plurality of second fibres (6) in the non-woven fabric (20) is between 1:3 and 3:1.

8. A wind turbine blade component (1) according to claim 1, wherein the non-woven fabric (20) has an area weight between 50 g/m2 and 200 g/m2, preferably between 70 g/m2 and 150 g/m2.

9. A wind turbine blade component (1) according to claim 1, wherein the plurality of first fibres (5) and the plurality of second fibres (6) in the non-woven fabric (20) are not held together by a binding agent or by stitching.

10. A wind turbine blade component (1) according to claim 1, wherein the laminate structure (2) further comprises
a plurality of fibre-reinforcing elements, including a first fibre-reinforcing element (30) and a second fibre-reinforcing element (40); and
a number of non-woven fabrics (20), including a first non-woven fabric (20) embedded in a first cured resin and being arranged between the first fibre-reinforcing element (30) and the second fibre-reinforcing element (40).

11. A wind turbine blade component (1) according to claim 10,
wherein the plurality of fibre-reinforcing elements (30, 40) each comprises a plurality of stacked fibre-reinforcing layers and/or
wherein the plurality of fibre-reinforcing elements are pre-cured fibre-reinforced elements, such as pultrusions comprising carbon fibres and/or glass fibres and/or wherein the number of non-woven fabrics (20) are interlayers for promoting resin infusion between the plurality of fibre-reinforcing elements.

12. A wind turbine blade component (1) according to claim 1, wherein the wind turbine blade component is a spar cap (10).

13. A method of manufacturing a wind turbine blade component, such as a spar cap (10), the method comprising the steps of:
providing a plurality of fibre-reinforcing elements including a first fibre-reinforcing element (30) and a second fibre-reinforcing elements (40);
providing a number of non-woven fabrics (20), including a first non-woven fabric (20) comprising a first plurality of fibres and a second plurality of fibres, wherein the first plurality of fibres are randomly oriented carbon fibres entangled with the second plurality of fibres which are a type of fibres different from carbon fibres;
arranging the first non-woven fabric (20) in between the first fibre-reinforcing element (30) and the second fibre-reinforcing element (40) such that the fibre-reinforcing elements (30,40) are separated by the first non-woven fabric (20);
infusing a first resin between the plurality of fibre-reinforcing elements and the number of non-woven fabrics (20);
curing the resin in order to form the wind turbine blade component (10).

14. A method of manufacturing a wind turbine blade component (1), such as a spar cap (10), according to claim 13, wherein the step of providing a first non-woven fabric (20) includes the steps of:
providing a number of webs or batts comprising a first plurality of fibres and a second plurality of fibres, wherein the first plurality of fibres are carbon fibres and the second plurality of fibres are a type of fibres different from carbon fibres, and
needle felting the first and second plurality of fibres to entangle the fibres until a predetermined area weight is obtained.

15. A method of manufacturing a wind turbine blade component (1) according to claim 14, wherein the plurality of fibre-reinforcing elements each comprises a plurality of stacked fibre-reinforcing layers and wherein the plurality of fibre-reinforcing elements are pre-cured fibre-reinforced elements, such as pultrusions comprising carbon fibres and/or glass fibres and wherein the number of non-woven fabrics (20) are interlayers for promoting resin infusion between the plurality of fibre-reinforcing elements.

16. A method of manufacturing a wind turbine blade component (1) according to claim 13, wherein the plurality of first fibres (5) are recycled carbon fibres and the step of providing the recycled carbon fibres includes recycling carbon fibres from wind turbine blade parts.

17. A wind turbine blade comprising a wind turbine blade component according to claim 1.
